(19) United States
(12) Patent Application Publication
(10) Pub. No.: US 2019/0130784 A1
(43) Pub. Date: May 2, 2019

(54) KINESTHETIC EDUCATION SYSTEM INCORPORATING COMMUNICATING MATHEMATICAL CONCEPTS AS A SPORT

(71) Applicant: Matt Oppenheimer, Camarillo, CA (US)

(72) Inventor: Matt Oppenheimer, Camarillo, CA (US)

(21) Appl. No.: 15/710,215

(22) Filed: Sep. 20, 2017

Related U.S. Application Data
(60) Provisional application No. 62/409,775, filed on Oct. 18, 2016.

(51) Int. Cl. G09B 19/00; G09B 23/02

(52) U.S. Cl. CPC G09B 19/0038; G09B 23/02

(57) ABSTRACT

Some embodiments of the present disclosure include a method for simultaneously teaching math and providing physical exercise in a unique manner in which the physical exercise promotes easier learning and retention of math skills and the kinesthetic learning of math encourages physical exercise, while improving balance and core body strength. The method includes assigning body stances and movement to correspond to numbers; assigning body stances and movement to mathematical operations; assigning body stances and movement to equation elements; allowing a Sender and a Receiver to spar, wherein sparring includes the Sender performing an equation through assigned stances and movements; the Receiver providing an answer using the assigned stances and movements; and the Sender confirming whether the answer is correct using an assigned movement; and repeating the sparring allowing the original Receiver and Sender to switch roles; and scoring each sparring round.

### BACKGROUND

The embodiments described herein relate generally to education, and more particularly, to an education system that competitively and kinesthetically communicates mathematical concepts as a sport.

Poor basic math skills and lack of sufficient exercise each have negative impacts on many youth throughout the world. Poor math skills result in lower rates of academic success, fewer job opportunities, and less productive job performance, as well as leading to costly mistakes throughout life due to math errors. Major issues preventing greater mastery of mathematical concepts include (1) many students do not enjoy studying (or are afraid of studying) math; (2) the existing systems and methods for presenting mathematical concepts do not work for all students, particularly those who are especially active and/or have difficulty focusing; (3) current methods do not sufficiently connect students' minds to the abstract concepts and, thus, retention of new information is poor; and (4) youth have difficult learning concepts now that they are told will be of use to them later. Students are motivated by what they want, here and now.

Concurrently, sufficient exercise is vital to good health, especially for children and teens, and there is a correlation between physical health and learning. Many educational programs have cut back on physical education due to funding and reallocation of time to academic subjects, such as math.

Therefore, what is need is a system that allows individuals to expedite and improve the acquisition of fundamental math skills via an integrated system that assigns unique body moves and poses to create numbers and mathematical operations, thus also providing physical fitness.

### SUMMARY

Some embodiments of the present disclosure include a method for simultaneously teaching math kinesthetically and providing physical exercise. The method includes assigning body stances and movements to correspond to numbers; assigning stances and movements to mathematical operations; assigning stances and movements to equation elements; allowing two students at a time (a Sender and Receiver) to spar using these assigned movements to create mathematical equations (sender) and corresponding answers (Receiver), wherein sparring includes the Sender performing an equation through assigned the stances and movements; the Receiver providing an answer using the assigned stances and movements; and the Sender confirming whether the answer is correct using an assigned movement; and repeating the sparring allowing the original Receiver and Sender to switch roles; and scoring each sparring round.

### BRIEF DESCRIPTION OF THE FIGURES

Having thus described the invention in general terms, reference is now made to the accompanying figures, which show different views of different example embodiments.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The method of the present disclosure may be used to simultaneously teach math and provide physical exercise and is comprised of the following elements. This list of possible constituent elements is intended to be exemplary only, and it is not intended that this list be used to limit the system of the present application to just these elements. Persons having ordinary skill in the art relevant to the present disclosure may understand there to be equivalent elements that may be substituted within the present disclosure without changing the essential function or operation of the device.

1. Poses and Movements that Express Numbers

2. Poses and Movements that Express Mathematical Operations

3. Poses and Movements that Express Aspects of Delivering Equations for Sparring

4. Sparring Sequence using the Poses and Moves

5. Scoring System

6. Support Materials (Worksheets, Explanations, Etc.)

The various elements of the method of the present invention may be related in the following exemplary fashion. It is not intended to limit the scope or nature of the relationships between the various elements and the following examples are presented as illustrative examples only.

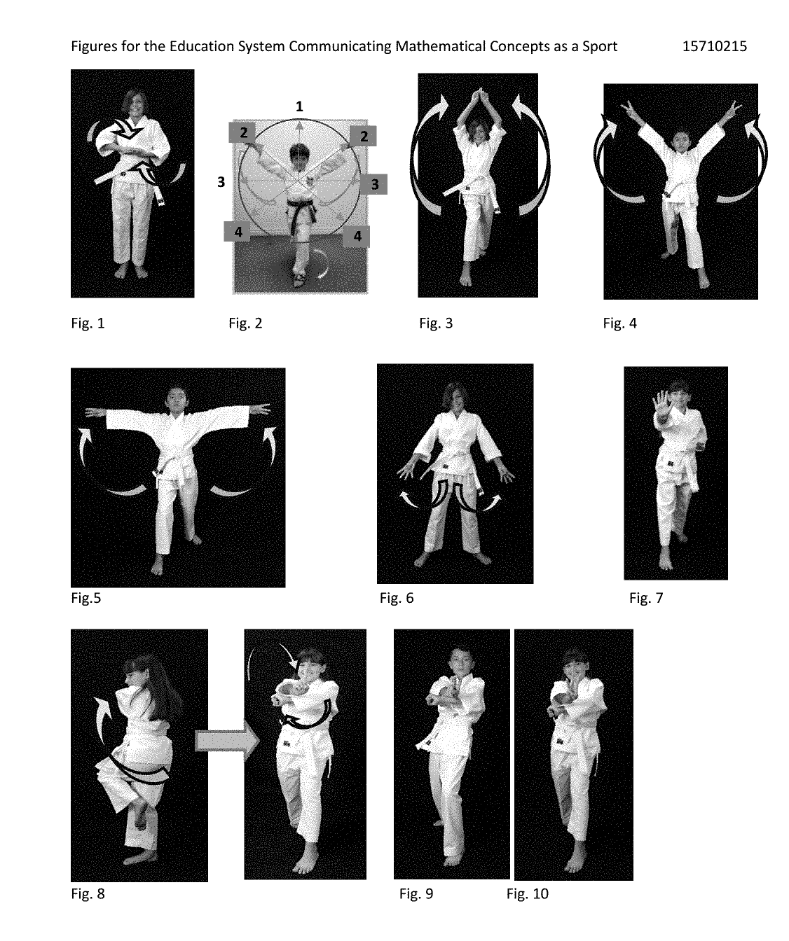

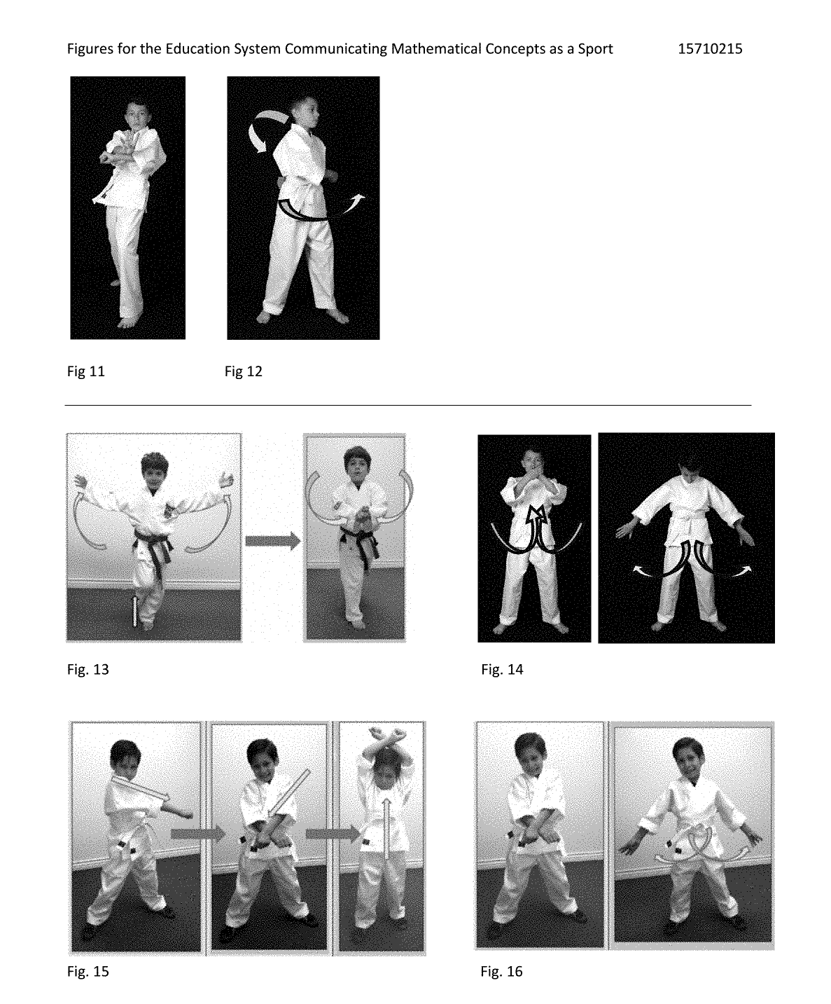

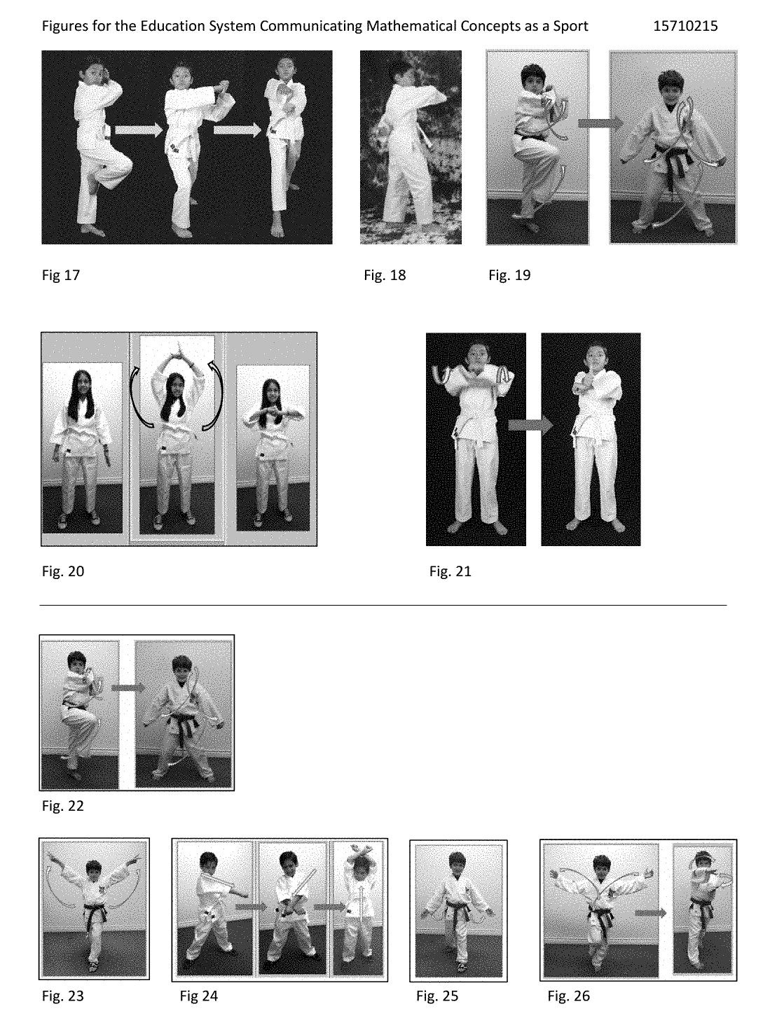

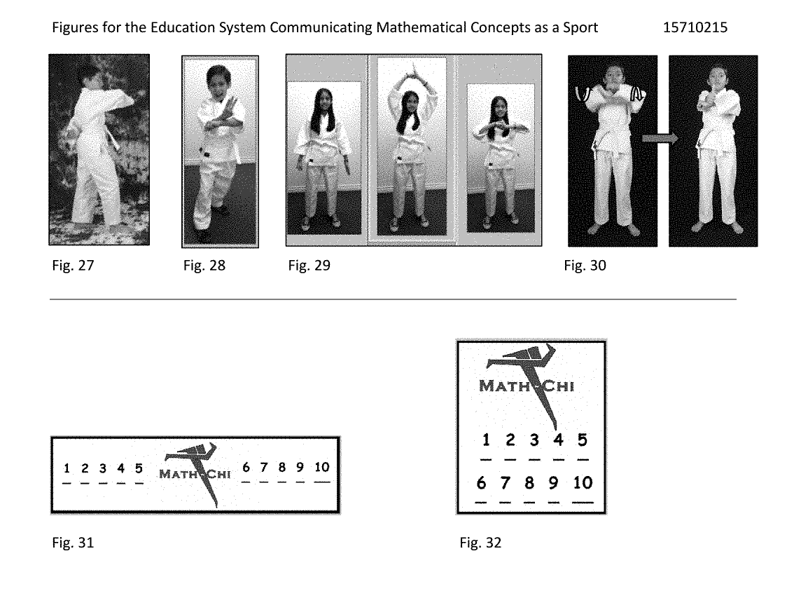

By way of example, and referring to FIGS. 1A-6, some embodiments of the invention include a method for simultaneously teaching math and providing physical exercise, the method comprising assigning stances and movements to correspond to numbers; assigning movements to mathematical operations; assigning movements to equation elements; allowing a Sender and a Receiver to spar; sparring comprising the Sender performing an equation through assigned the stances and movements; the Receiver providing an answer using the assigned stances and movements; and the Sender confirming whether the answer is correct using an assigned movement; repeating the sparring allowing the original Receiver to send an equation and the original Sender to receive the equation; and scoring each sparring round. The method may further comprise providing supporting materials, such as the worksheets shown in FIG. 6, to help the individuals learn the underlying math upon which the equations are based.

As shown in FIGS. 1A through 1C, specific stances are assigned to each number beginning with the numbers zero to 9, then beyond by using additional moves to indicate multiple-digit numbers. Exemplary stances are shown and described in FIGS. 1A through 1C.

As shown in FIGS. 2A and 2B, specific movements are assigned to certain mathematical operations. For example, each of addition, subtraction, multiplication, and division are assigned a respective movement. Exemplary movements are shown and described in FIGS. 2A and 2B. For example, multiplication is comprised of the Sender making a downward punching movement in-front/across the send's body followed by the Senders other fist punching downward and across the first arm to form an “X” which is visible to the Receiver as the sign that the preceding number and the one to follow are to be multiplied together. Because there is a mathematical relationship between multiplication and division, the movements for division is a reflection of multiplication in that the Sender makes simultaneous downward punching movements with both hands to form an “X,” then immediately arcs both hands downward and out to the Sender's side in an arc as the hands transition from clenched fists to open with palms facing outward.

As shown in FIGS. 3A and 3B, specific movements are assigned to specific equation and sparring elements. For example, each of the “Equals,” “Ready/Watch/Hold,” “Start” (of an equation), “Finished,” and confirming or rejecting the Receiver's answer are assigned a respective movements. Exemplary poses and movements are shown and described in FIGS. 3A and 3B.

To use the system of the present disclosure, the Sender may begin by performing the start move and an equation. While the Sender is performing, the Receiver may wait in the hold position. When the Sender is finish, the Receiver may perform the movement(s) corresponding with the answer and then the finished movement. The Sender will than confirm or reject the Receiver's answer by performing the respective movement. An exemplary sequence is shown and described in FIGS. 4A and 4B.

When desired, users of the system keep track of sparring scores, rankings, and mastery of mathematical concepts. To demonstrate mastery of concepts, students perform the corresponding demonstration (Kata) to their instructor and upon successful completion of the Kata, is awarded the corresponding certification of mastery. Said certification takes the form of sign-off by the instructor in the student's log, certificates, awards, and/or a marking system depending upon the type and level of math and/or movements mastered. Belt Patches may be centered at the back of a belt which are marked for each new table mastered. This allows for easy visibility while preventing interference with known martial arts belt rankings. Additional certification points can be earned by students for: (1) the combination of arriving on time, being attentive throughout class, and staying until the end; (2) assisting during a session as an Apprentice Instructor; and (3) each point scored in a match while sparring. Exemplary patches and methods for scoring are shown and described in FIG. 5 (5a-5c).

In some embodiments, sparring points are assigned in a manner designed to ensure that the Sender as well as the Receiver knows the answers to the equations being created by the Sender as follows. The Receiver earns a point by correctly answering the Sender's equation. The Sender earns a point if the Receiver answers the equation incorrectly and the Sender sends a Thumbs-Down. The Receiver, however, earns TWO points if the Sender sends a Thumbs-Down in response to a correct answer. If the Receiver answers the equation incorrectly and the Sender incorrectly sends a Thumbs-Up, then neither the Receiver nor the Sender earn a point. Performing an operation NOT included in the match's parameters gives that equation's point to the Receiver. Exemplary detail for accruing and recording points are described in FIG. 5

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claim.

What is claimed is:

1. A method for simultaneously teaching math and providing physical exercise, the method comprising:
assigning stances and movements to correspond to numbers;
assigning stances and movements to mathematical operations;
assigning stances and movements to equation elements;
allowing a Sender and a Receiver to spar, sparring comprising:
the Sender performing an equation through assigned stances and movements;
the Receiver providing an answer using the assigned stances and movements; and
the Sender confirming whether the answer is correct using an assigned stance and movement; and
repeating the sparring allowing the original Receiver and Sender to switch roles; and scoring each sparring round.
